(19) United States
(12) Patent Application Publication
(10) Pub. No.: US 2009/0300738 A1
(43) Pub. Date: Dec. 3, 2009

(54) Authentication Methods and Systems

(75) Inventors: Caroline Mostyn Dewe, Wellington (NZ); Horatiu Nicolae Parfene, Churton Park (NZ); Antony John Williams, Wadestown (NZ); Sergio Alvarez Diaz, Paekakariki (NZ); Jonathan Paul Ide, Days Bay (NZ)

Correspondence Address: NIXON & VANDERHYE, PC, 901 NORTH GLEBE ROAD, 11TH FLOOR, ARLINGTON, VA, 22203, US

(73) Assignee: FRONDE ANYWHERE LIMITED, Wellington (NZ)

(21) Appl. No.: 12/085,777

(22) PCT Filed: Jun. 14, 2007
(86) PCT No.: PCT/NZ2007/000155

§ 371 Date: Jun. 25, 2009

(30) Foreign Application Priority Data
Jun. 14, 2006 (NZ) 547903
May 17, 2007 (NZ) PCT/NZ2007/000115

(51) Int. Cl. H04L 9/32; G06F 15/16; G06F 9/445; H04L 29/06

(52) U.S. Cl. 726/6; 709/217; 717/178; 713/150; 713/176; 726/9

(57) ABSTRACT

A method of generating an authentication token using a cryptographic based application downloaded to a mobile telephony device and a method of authenticating an online transaction using such a token. The method may be employed in a two factor authentication method uitilising a user password and an authentication token. The method allows a two factor authentication method to be provided by a wide range of mobile telephony devices operating either online or offline. Other authentication systems and methods of authentication are also disclosed.

### FIELD OF THE INVENTION

This invention relates to systems for and methods of authentication including a method of generating an authentication token using a cryptographic based application downloaded to a mobile telephony device and to a method of authenticating an online transaction using such a token. The method may be employed in a two factor authentication method utilising a user password and an authentication token.

### BACKGROUND OF THE INVENTION

It is common to employ single factor authentication for online financial transactions. Whilst services such as Internet banking commonly only require single factor authentication (i.e. a user ID and password) greater security is desirable with an increasing range of threats from key-loggers, Trojans, phising/pharming attacks, man in the middle (MITM) attacks, shoulder surfing, interception, decompilation of security applications, substitution of applications and recreation of security tokens.

Two factor authentication provides stronger protection as this requires two methods of authentication (e.g. a security token or key in combination with a user password). A number of methods for generating and distributing security tokens for use in online transactions are known as described in WO02/19593, WO01/17310 and WO03/063411. The token is not generated locally and the methods do not allow the second authentication method to be used where the wireless communications channel is unavailable.

The above methods employ single use tokens (which must be applied for to conduct each transaction) or persistent tokens. Single use tokens are inconvenient in requiring a user to request a token for each transaction. Persistent tokens pose a security risk should a third party obtain the token whilst it may still validly be used. WO 02/15626 discloses a cellular phone including a cryptographic module which can generate a security token locally on the cellular phone. However, this approach is limited to cellular phones having such a cryptographic module.

It would be desirable to provide an authentication method requiring minimal user input which provides strong security. It would be desirable for the authentication process to be activatable via a range of channels requiring minimal user involvement. It would also be desirable if the process could be used with a wide range of mobile devices. It would be desirable for a token to be able to be generated whilst the mobile telephony device is offline. The authentication process should also provide good protection against spoofing, phishing, interception, software decompilation, manipulation of data or software and accessing of a security token. It should also minimise possible repudiation of a transaction by a user.

It is an object of the invention to provide methods and systems which reduce at least some of the aforementioned disadvantages or at least provide the public with a useful choice.

### EXEMPLARY EMBODIMENTS

A number of embodiments are described herein and the following embodiments are to be read as non-limiting exemplary embodiments only.

According to one exemplary embodiment there is provided a method of generating an authentication token comprising the steps of:
i. downloading a cryptographic based application to a mobile telephony device;
ii. running the cryptographic based application on the mobile telephony device; and
iii. displaying a token generated by the cryptographic based application on a display of the mobile telephony device.

There is also provided a mobile telephony device configured to effect the method and software for implementing the method.

According to another embodiment there is provided a method of authenticating a transaction comprising:
i. downloading a cryptographic based application to a mobile telephony device;
ii. supplying first authentication information to an authentication device;
iii. generating second authentication information using the cryptographic based application of the mobile telephony device;
iv. supplying the second authentication information to the authentication device; and
v. verifying the first and second authentication information by the authentication device.

There is further provided a system configured to effect the method and software to implement the method.

According to another embodiment there is provided a method of authenticating a transaction comprising:
a. generating an authentication token at a mobile device based on seed data and local time data wherein the token includes time of generation information;
b. transmitting the authentication token to an authentication system;
c. extracting the time of generation information from the token; and
d. authenticating the token only if the time of generation information is within a prescribed window with respect to the time of receipt at the authentication system.

According to another embodiment there is provided a method of verifying the authenticity of an application downloaded to a mobile telephony device comprising:
a. sending a user specific URL to a user of a mobile telephony device;
b. downloading an application from the user specific URL to the mobile telephony device;
c. storing the user specific URL in memory of the mobile telephony device separately from the application; and
d. verifying that the installed application was downloaded from the user specific URL before running the application.

According to another embodiment there is provided a method of verifying the authenticity of a transaction between a mobile telephony device and a remote authentication system comprising:
a. inserting a user specific signature in an application downloaded to the mobile device;
b. storing the user specific signature at the remote authentication system;
c. generating an authentication token at the mobile telephony device based at least in part on the user specified signature using the downloaded application;
d. sending the authentication token to the authentication system; and
e. verifying the authentication token at the remote computer including verifying that the authentication token was generated using the user specified signature.

### BRIEF DESCRIPTION OF THE DRAWINGS

The accompanying drawing illustrates an embodiment of the invention and, together with the general description of the invention given above, and the detailed description of embodiments given below, serve to explain the principles of the invention.

FIG. 1 shows a schematic diagram of a system suitable for implementing the authentication method of the invention.

### DESCRIPTION OF EMBODIMENTS OF THE INVENTION

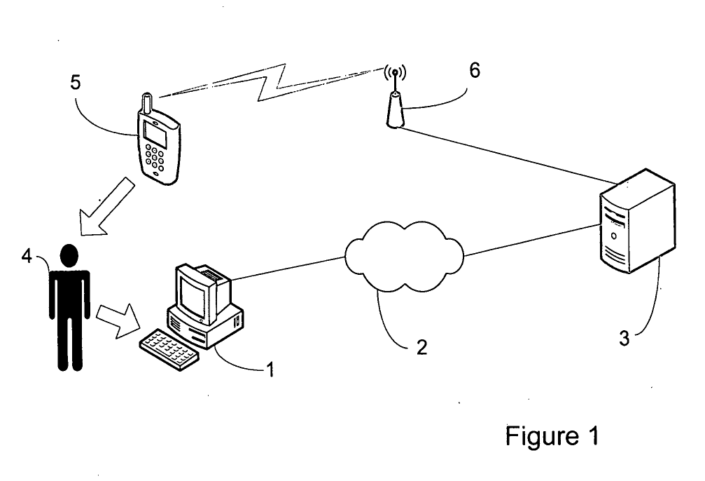

FIG. 1 shows schematically one possible system for implementing the authentication method of the invention. A local computer 1 is connected via a telecommunications network 2 to an authentication system 3. In an exemplary embodiment local computer 1 may access Internet banking services provided by authentication system 3 via a browser on local computer 1. The authentication system may be a single computer or a distributed computer system.

To provide two factor authentication according to a first embodiment a user 4 may enter an ID and password into local computer 1 and a token generated by mobile telephony device 5. To enable generation of a token by the mobile telephony device 5 a user may request that a cryptographic based application be provided. A user may request the cryptographic based application through one of a number of channels as follows:
1. At a bank—a user may visit a branch of their bank, validate their identity and have a cryptographic based application downloaded to their mobile wireless device 5 wirelessly, via removable media, via a data line etc.;
2. SMS—a user may send an SMS message requesting a cryptographic based application, the bank may verify the credentials and, if satisfied, instruct remote computer 1 to send the cryptographic based application to the client;
3. Telephone—a user may telephone the bank requesting mobile banking. Either IVR or a human operator may be employed. Upon verifying user credentials remote computer 3 may be instructed to send the cryptographic based application to the client; or
4. Internet banking—during an Internet banking session a user may request a cryptographic based application. As the credentials of the user have been verified during the logon to Internet banking the cryptographic based application may be automatically sent to the user.

It will be appreciated that an application may be made in a variety of ways and the above are exemplary only.

One method of sending the cryptographic based application is to send a URL in an SMS message via wireless network 6 to mobile telephony device 5. A user may activate the URL link and download the cryptographic application using https protocol. It will be appreciated that a number of methods of downloading the cryptographic based application to the mobile telephony device 5 could be employed depending upon the security requirements for the particular application. A user specific URL may be supplied so that a user specific application may be downloaded. This user specific application may include the user specific URL; a user specific signature (which may be included in a JAR file) and/or a user secret. These will preferably be stored in an obfuscated manner within the application. The user secret may be an arbitrarily assigned code, a user ID and password or other combinations as would be apparent to one skilled in the field.

To activate the cryptographic based application an activation code may need to be entered into the mobile telephony device 5 when the cryptographic based application installs. This may be a unique code provided to a user via an SMS message, e-mail, by post etc. or could be a user's ID and password. When the unique code is entered into mobile telephony device 5 it may be sent using https protocol over wireless network 6 to authentication system 3. Once authentication system 3 verifies the activation code it will accept tokens generated by mobile telephony device 5 for that user.

The cryptographic based application running on mobile telephony device 5 may employ a hash function such as the SHA 512 digest function. The user secret, user specific signature and/or the user specific URL embedded within the cryptographic based application may be used to generate authentication information in the form of a token. A time related factor, such as the elapsed time from a certain start time, may also be used to generate a token. In an exemplary embodiment a token may be generated using the cryptographic based application based on the user secret, user specific signature and user specific URL embedded within the cryptographic based application and the time that has elapsed since an arbitrary date such as (1 Jan. 1970) as seed data.

The cryptographic based application supplied to the mobile telephony device 5 preferably provides a high-level of security. Features that may achieve this include:
1. obfuscated code (i.e. compressed and unintelligible code)
2. virtual machines (i.e. each application runs in its own space without interaction with other components)
3. pre-verified code (i.e. checked to ensure it cannot override machine classes)

To achieve these features it is preferred that the application is written in a language such as Java J2ME code.

When logging on to a service such as Internet banking a user may enter their ID and password into a browser running on computer 1 as a first form of authentication, generate a token on mobile telephony device 5 using the cryptographic based application and enter the token generated and displayed by mobile telephony device 5 into the browser as the second form of authentication. A token may be generated by mobile telephony device 5 whilst it is offline allowing the method to the employed where there is no coverage or a user does not have access to an available system.

The first authentication information (user ID and PIN) is sent to authentication system 3 for validation. Authentication system 3 generates a token based on the same seed data as is embedded in the cryptographic based application provided to the user and the time at the time of validation. The authentication token received will be validated if the time at the mobile telephony device 5 at the time of generation and the time at the remote computer at the time of validation is within a specified time window. This may be achieved by rounding the time input value so that a token generated at authentication system 3 within a specified time window will match the token generated by the mobile telephony device 5. This ensures that any intercepted token has short persistence. Authentication system 3 may also check to ensure that any token is only used once.

If the clock of the mobile telephony device 5 is not synchronised with the clock of authentication system 3 the time window may be too short or, if too far out of synchronisation, may not allow validation of any tokens. Either, the clock of mobile telephony device 5 may be periodically synchronized with the clock of the authentication system 3 or an offset technique may be employed. For the offset technique a delta value may be stored by the mobile telephony device 5 at the time of installation recording the offset between the clock of the mobile telephony device 5 and authentication system 3. This delta value may subsequently be used to offset the elapsed time when generating a token.

In another embodiment the time of generation of the authentication code may be included in the authentication token, preferably in a manner making it difficult to extract. A preferred approach is to make the location of this information within the token dependent upon user specific information selected from one or more of: a user specific signature, a user secret, a user pass code (PIN) and user account details. The actual time of generation may then be extracted by the authentication system (where the user specific information is stored and used to extract the time information) and used to generate a token locally to compare to the received token to verify authenticity of the token. This approach avoids the complexity of covering the range of valid times of generation within a window and comparing these to the token.

In another embodiment the authentication token may be sent via a separate channel such as wireless network 6 to provide greater security where required for particularly sensitive transactions. In this embodiment the token is generated by mobile telephony device 5 upon activation of the cryptographic based application by a user and is sent via wireless network 6 to authentication system 3. This technique could be used in conjunction with the previous technique where greater security is required or on its own.

The above methods provide an authentication process to enable a secure transaction to be conducted. In another embodiment a token may be generated including transaction information. According to this aspect the method above requires a user to enter transaction information, such as the payee account and amount, which may be used as a seed value for the cryptographic based application to generate an authentication token in conjunction with one or more of the following seed values:
1. time of generation of the cryptographic based application
2. user specific signature
3. user secret
4. a user passcode (PIN and/or user ID not stored on the mobile telephony device))

In this embodiment authentication system 3 may validate the token as described above and if validated process the application according to transaction information. This prevents a man in the middle modifying transaction information once a channel is validated by a valid token.

As an additional security measure the cryptographic based application when downloaded may store the user specific URL from which it was downloaded in a separate area of memory within mobile telephony device 5 to the memory area storing the application. Each time the application runs it checks the URL stored separately in the mobile device to check that it concurs with the user specific URL stored in the application before the application generates an authentication token. In this way substitution of an application not having a different URL stored therein will not generate a token.

There is thus provided methods and systems that can be applied to a wide range of existing wireless telephony devices without requiring any cryptographic functionality to be provided in the phone. The method can be applied easily to existing systems without major modification or additional system components; making the method easily scalable, cost effective to deploy, manage and support. The method may be easily deployed to and used by customers. The method provides a high-level of security due to the independent generation of a time limited code by a separate device. A single use token reduces the risk from key-loggers, and Trojans. Using time limited tokens reduces the risk of phishing/pharming and MITM attacks. Further, the software makes it extremely difficult to access or change software or data. The relationship between a specific mobile device and its token generating software limits possible repudiation of a transaction by a user.

Although the method and system of the invention has been described in relation to an Internet banking application it will be appreciated that the method of the invention may find a wide range of applications beyond this application such as authentication at ATM machines, retail outlets etc.

While the present invention has been illustrated by the description of the embodiments thereof, and while the embodiments have been described in detail, it is not the intention to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the applicant's general inventive concept.

1. A method of generating an authentication token comprising the steps of:
i. downloading a cryptographic based application to a mobile telephony device;
ii. running the cryptographic based application on the mobile telephony device; and
iii. displaying a token generated by the cryptographic based application on a display of the mobile telephony device.

2. A method as claimed in claim 1 wherein the token is generated whilst the mobile telephony device is offline.

3. A method as claimed in claim 1 wherein the token is generated whilst the mobile telephony device is online.

4. A method as claimed in claim 1 wherein a URL link is sent to the mobile telephony device to enable downloading of the cryptographic based application.

5. A method as claimed in claim 4 wherein an SMS message including the URL link is sent to the mobile telephony device.

6. A method as claimed in claim 4 wherein the URL link is sent in response to a request made during an internet banking session.

7. A method as claimed in claim 4 wherein the URL link is sent in response to a request made via an IVR service.

8. A method as claimed in claim 1 wherein the application is downloaded using a secure protocol.

9. A method as claimed in claim 4 wherein a user specific URL is sent to each user.

10. A method as claimed in claim 4 wherein the cryptographic based application includes a user specific signature.

11. A method as claimed in 10 wherein the user specific signature is stored in a JAR file.

12. A method as claimed in claim 10 wherein the generated token is generated at least in part based on the user specific signature.

13. A method as claimed in claim 1 wherein the generated token is based on a time related factor.

14. A method as claimed in claim 13 wherein the time related factor is elapsed time from a start time.

15. A method as claimed in claim 1 wherein the generated token is generated at least in part based on a unique security code assigned to the user.

16. A method as claimed in claim 15 wherein the unique security code is embedded in the downloaded cryptographic based application.

17. A method as claimed in claim 1 wherein the generated token is generated at least in part based on a user entered code.

18. A method as claimed in claim 17 wherein the user entered code includes a PIN.

19. A method as claimed in claim 1 wherein the cryptographic based application uses a hash function.

20. A method as claimed in claim 19 wherein the hash function is based on a SHA 512 digest function.

21. A method as claimed in claim 1 wherein the cryptographic based application requires an activation code to be entered to enable the application.

22. A method as claimed in claim 21 wherein the activation code is a unique code supplied to a user.

23. A method as claimed in claim 21 wherein the activation code is a user ID and a password.

24. A method as claimed in claim 1 wherein an activation code must be sent to a remote computer to enable tokens generated by the mobile telephony device to be accepted by the remote computer.

25. A method as claimed in claim 21 wherein the activation code includes a user specific signature from the cryptographic based application.

26. A method as claimed in claim 21 wherein the activation is sent using a secure protocol.

27. A method as claimed in claim 21 wherein the activation code is a unique code supplied to a user.

28. A method as claimed in claim 27 wherein the activation code is a user ID and a password.

29. A method of authenticating a transaction comprising:
i. downloading a cryptographic based application to a mobile telephony device;
ii. supplying first authentication information to an authentication system;
iii. generating an authentication token using the cryptographic based application of the mobile telephony device;
iv. supplying the authentication token to the authentication system; and
v. verifying the first authentication information and authentication token by the authentication system.

30. A method as claimed in claim 29 wherein the authentication system is a remote computer.

31. A method as claimed in claim 29 wherein the authentication token is generated whilst the mobile telephony device is offline.

32. A method as claimed in claim 31 wherein the first authentication information and the authentication token are sent via the same communications channel.

33. A method as claimed in claim 32 wherein the first authentication information and the authentication token are sent via the internet.

34. A method as claimed in claim 27 wherein the authentication token is generated whilst the mobile telephony device is online.

35. A method as claimed in claim 34 wherein the authentication token is sent via a wireless communications channel.

36. A method as claimed in claim 29 wherein the first authentication information is static information.

37. A method as claimed in claim 36 wherein the first authentication information is a user ID and password.

38. A method as claimed in claim 29 wherein the authentication token is transient information.

39. A method as claimed in claim 29 wherein the authentication token is generated on the basis of time based information.

40. A method as claimed in claim 39 wherein the authentication token is generated on the basis of a time related factor.

41. A method as claimed in claim 40 wherein the time related factor is elapsed time from a start time.

42. A method as claimed in claim 41 wherein an offset between the time of a clock of the mobile telephony device and the time of a clock of the authentication system is stored in the mobile telephony device and used to synchronise the time related factor between the mobile telephony device and the remote computer.

43. A method as claimed in claim 39 wherein the authentication system verifies the authentication token by generating an authentication token locally and comparing it to the authentication token received.

44. A method as claimed in claim 42 wherein the authentication system will only validate the authentication token received if it has been generated within a prescribed period of receipt by the remote computer.

45. A method as claimed in claim 39 wherein the authentication token includes information as to its time of generation which is extracted and validated if the time of generation is within a specified window with respect to the time of verification at the authentication system.

46. A method as claimed in claim 45 wherein the time of generation of the authentication token is stored at a location within the token based on user specific information.

47. A method as claimed in claim 30 wherein a user specific signature is stored at the authentication device and is included in the cryptographic based application and is used to generate the authentication token and the authentication system verifies the authentication token based at least in part on the user specific signature.

48. A method as claimed in claim 47 wherein the user specific signature is stored in a JAR file.

49. A method as claimed in claim 30 wherein a user secret is stored in the authentication system and is included in the cryptographic based application and is used for generation of the authentication token and the authentication system verifies the authentication token based at least in part on the user specific signature

50. A method as claimed in claim 1 wherein the mobile telephony device is a cellular phone.

51. A system configured to operate in accordance with the method of claim 29.

52. A mobile telephony device configured to operate in accordance with the method claim 1.

53. A method of authenticating a transaction comprising:
a. generating an authentication token at a mobile device based on seed data and local time data wherein the token includes time of generation information;
b. transmitting the authentication token to an authentication system;
c. extracting the time of generation information from the token; and
d. authenticating the token only if the time of generation information is within a prescribed window with respect to the time of receipt at the authentication system.

54. A method as claimed in claim 53 wherein the time of generation information is inserted at a location within the token based on user specific information

55. A method as claimed in claim 54 wherein the time of generation information is inserted at a location within the token based on user specific information selected from one or more of: a user specific signature, a user secret, a user pass code and user account details

56. A method of verifying the authenticity of an application downloaded to a mobile telephony device comprising:
a. sending a user specific URL to a user of a mobile telephony device;
b. downloading an application from the user specific URL to the mobile telephony device;
c. storing the user specific URL in memory of the mobile telephony device separately from the application; and
d. verifying that the installed application was downloaded from the user specific URL before running the application.

57. A method as claimed in claim 56 wherein the user specific URL is stored in an obfuscated manner within the application.

58. A method of verifying the authenticity of a transaction between a mobile telephony device and a remote authentication system comprising:
a. inserting a user specific signature in an application downloaded to the mobile device;
b. storing the user specific signature at the remote authentication system;
c. generating an authentication token at the mobile telephony device based at least in part on the user specified signature using the downloaded application;
d. sending the authentication token to the authentication system; and
e. verifying the authentication token at the remote computer including verifying that the authentication token was generated using the user specified signature.

59. A method as claimed in claim 58 wherein the user specific signature is stored in a JAR file.

60. A method as claimed in claim 1 wherein transaction details are entered by a user and used to generate the authentication token.

61. A method as claimed in claim 60 wherein the transaction information includes the payee account and the amount of the payment.

62. A method as claimed in claim 60 wherein once the token is authenticated a transaction is completed according to the transaction information.

63. Software configured to effect the method of claim 1.
